(19) United States
(12) Patent Application Publication
(10) Pub. No.: US 2011/0192137 A1
(43) Pub. Date: Aug. 11, 2011

(54) Method for Manufacturing a Regeneratively Cooled Nozzle Extension of a Rocket Combustion Chamber and Nozzle Extension

(75) Inventor: Chris Udo MAEDING, Unterschleissheim (DE)

(73) Assignee: Astrium GmbH, Taufkirchen (DE)

(21) Appl. No.: 13/012,215

(22) Filed: Jan. 24, 2011

(30) Foreign Application Priority Data
Feb. 8, 2010 (DE) 102010007272.9-14

(51) Int. Cl. F02K 9/00; B21D 53/00

(52) U.S. Cl. 60/267; 29/890.01

(57) ABSTRACT

A method for manufacturing a regeneratively cooled nozzle extension of a rocket combustion chamber, the nozzle extension including a first wall and a second wall arranged coaxially to each other and between which a number of cooling channels is configured that are laterally delimited by cooling channel webs. The first wall and the second wall are connected to each other by a positive fit by cooling channel webs of the first wall engaging with corresponding recesses of the second wall for forming the positive fit. The positive fit is produced by a forming process in the region of the cooling channels of the second wall having the recesses.

### CROSS REFERENCE TO RELATED APPLICATIONS

This application which claims priority under 35 U.S.C. §119 to German Patent Application No. 10 2010 007 272.9-14, filed Feb. 8, 2010, the entire disclosure of which is herein expressly incorporated by reference.

### BACKGROUND AND SUMMARY OF THE INVENTION

The invention relates to a method for manufacturing a regeneratively cooled nozzle extension of a rocket combustion chamber, the nozzle extension comprising a first wall and a second wall which are arranged coaxially to each other and between which a number of cooling channels is configured. The cooling channels are laterally delimited by cooling channel webs. In the method, the first and the second wall are connected to each other by a positive fit by cooling channel webs of the first wall engaging with corresponding recesses of the second wall for forming the positive fit.

The invention also relates to a regeneratively cooled nozzle extension for a rocket combustion chamber, the nozzle extension comprising a first and a second wall which are arranged coaxially to each other and between which a number of cooling channels is configured. The cooling channels are laterally delimited by cooling channel webs. In the nozzle extension, the first and the second wall are connected to each other by a positive fit by cooling channel webs of the first wall engaging with corresponding recesses of the second wall for forming the positive fit.

Nozzle extensions of rocket combustion chambers represent thermally highly loaded components. For reducing the thermal load, the nozzle extensions are cooled. This takes place primarily by incorporating cooling channels through which at least one fuel component flows to extract heat from the wall of the nozzle extension. The heated fuel component or components is or are, respectively, fed at the outlet from the cooling channels to the drive system for the final reaction in the rocket combustion chamber. Alternatively, the fuel components can be ejected via separate systems to generate a thrust.

From the prior art, different methods for manufacturing regeneratively cooled extension nozzles comprising cooling channels are known.

U.S. Pat. No. 6,467,253 B1 discloses a method in which segments of the nozzle extension each of which consist of an inner and an outer wall connected to each other by a positive fit by cooling channel webs of the inner wall engaging with corresponding recesses of the outer wall for forming the positive fit. A plurality of the segments is connected to each other via a welded joint to form a rotationally symmetric nozzle extension. Due to the construction, the cooling channels have a small cross-section here, which limits the cooling capacity.

U.S. Pat. No. 6,789,316 B2 discloses a method in which Y-shaped profile members are welded together to form corresponding cooling channels. This requires a nozzle extension manufactured from a plurality of such profile members, which is a costly manufacturing method.

US 2006/0213182 A1 discloses arranging an inner wall having cooling channel webs and an outer wall having a smooth inner side on top of each other and to interconnect them by brazing.

Manufacturing methods using brazing and welding joints are characterized by a very high production-related expenditure.

Exemplary embodiments of the present invention provide a method by means of which a regeneratively cooled nozzle extension of a rocket combustion chamber can be manufactured in a simpler manner, wherein the regeneratively cooled nozzle extension resulting therefrom has to have a high cooling efficiency. Furthermore, exemplary embodiments of the present invention provide a regeneratively cooled nozzle extension that can be manufactured in a simple manner and has a high cooling efficiency.

The invention provides a method for manufacturing a regeneratively cooled nozzle extension of a rocket combustion chamber, the nozzle extension comprising a first and a second wall are arranged coaxially to each other and between which a number of cooling channels is configured, the cooling channels being laterally delimited by cooling channel webs. The first and the second wall are connected to each by a positive fit by cooling channel webs of the first wall engaging with corresponding recesses in the second wall for forming the positive fit. According to the invention, the positive fit is generated by a forming process in the region of the cooling channels of the second wall having the recesses.

The method according to the invention allows the simple manufacture of a regeneratively cooled nozzle extension because it can be manufactured substantially with mechanical processing steps. By principally avoiding the use of brazing and welding methods, the production-related expenditure for manufacturing the regeneratively cooled nozzle extension can be kept low, thereby also lowering the costs for manufacturing the nozzle extension.

Advantageously, the forming of the second wall is carried out from a side opposing the first wall. In this manner, producing the positive fit can take place in a simple and fast manner.

In order to be able to implement a fast and efficient manufacture of the nozzle extension, the forming can take place in the region of one cooling channel or in the region of a plurality of cooling channels at the same time. For manufacturing the complete nozzle extension, the positive fit is then generated in the region of one or a plurality of cooling channels in a plurality of sequentially staggered method steps.

According to one configuration variant, the force necessary for forming the second wall can be applied by one or by a plurality of rollers arranged side-by-side and/or one behind the other. By a plurality of rollers arranged side-by-side, the simultaneous forming of a plurality of cooling channels can be implemented, which accelerates manufacture. In principal, the forming can also be carried out with other suitable tools.

Alternatively or additionally, excess pressure and/or negative pressure can be used for forming the second wall. The forming can also be implemented, for example, by providing a negative pressure in the region of the cooling channels and a simultaneous excess pressure on the second wall.

It is further provided that prior to the forming step, the first and the second wall are positioned as a whole in axial direction one above the other in such a manner that at least some cooling channel web ends remote from the first wall project into the recesses. Then, for producing the positive fit, only the forming of the second wall having the recess is necessary in the region of the cooling channels. “As a whole” means that not only individual segments are positioned on top of each other but the first and second walls which are already parabolically shaped are arranged on top of each other.

In a first alternative, the forming takes place in the region between two directly adjacent cooling channel webs. In another alternative, the forming takes place in the region of one or a plurality of adjacent cooling channel webs in such a manner that the second wall is brought into abutment against the web end remote from the first wall of one or a plurality of cooling channel webs without producing a positive fit, wherein the positive fit between the first and the second wall takes place at least by the cooling channel webs adjacent to the cooling channel webs. This provides a simpler and faster manufacturing of the nozzle extension because a smaller number of forming steps for manufacturing the complete nozzle extension are necessary. Moreover, by this configuration variant, the shape of the cooling channels can be varied in a desired manner.

Advantageously, the forming takes place in such a manner that each nth cooling channel web is connected in a positively fitting manner to the second wall, wherein n is greater than 2. For example, the forming of the second wall can take place in such a manner that only every second or third cooling channel web is used for the formation of the positively fitting connection. This means, between the cooling channel webs provided for the forming process, additional, shorter cooling channel webs are introduced on the first wall, the height of which webs is determined in consideration of the necessary deformation and flow conditions.

For stiffening the regeneratively cooled nozzle extension it can further be provided that at least one stiffening ring with a predetermined axial length is brought into abutment against the second wall of the nozzle extension so that the stiffening ring lies in a plane that is orthogonal to a rotational axis of the nozzle extension. A respective stiffening ring increases the stiffness of the nozzle extension, in particular in the region of the geometry changed by forming. Depending on the configuration of the axial length of a respective stiffening ring (up to a monolithic outer skirt which can be comparable with the length of the nozzle extension or individual sections), the stiffness of the nozzle extension can be maximally influenced.

The at least one stiffening ring can have a projection in the region of the deformations, where the projection is adapted to the shape of the deformations, whereby the shape of the second wall in the region of the cooling channels is raised when the internal pressure (due to a cooling medium flowing through the cooling channels) is applied.

Furthermore, the invention provides a regeneratively cooled nozzle extension for a rocket combustion chamber, the nozzle extension comprising a first wall and a second wall that are arranged coaxially to each other and between which a number of cooling channels are configured that are laterally delimited by cooling channel webs. In case of the nozzle extension, the first and the second wall are connected to each other by a positive fit, wherein cooling channel webs of the first wall engage with corresponding recesses of the second wall for producing the positive fit. In the region of a respective positive fit, according to the invention, the second wall having recesses is shaped by forming in the region of the cooling channels.

The regeneratively cooled nozzle extension according to the invention can be manufactured in a simple and cost-effective manner, wherein a sufficient cooling efficiency is ensured due to the inventive connection method.

It is advantageously provided that the first and the second wall each have a rotationally symmetric, in particular, parabolic initial contour.

In a further advantageous configuration it is provided that each nth cooling channel web is connected to the second wall in a positively fitting manner, wherein n is greater than 2.

According to a further configuration, a stiffening ring with predetermined axial length is brought into abutment against the second wall of the nozzle extension so that the stiffening ring lies in a plane orthogonal to a rotational axis of the nozzle extension.

Other objects, advantages and novel features of the present invention will become apparent from the following detailed description of one or more preferred embodiments when considered in conjunction with the accompanying drawings.

### BRIEF DESCRIPTION OF THE DRAWINGS

The invention is described in more detail hereinafter by means of exemplary embodiments. In the figures:

FIG. 1 shows a nozzle extension according to the invention in an exploded perspective illustration,

FIG. 2 shows an enlarged, perspective detail of a nozzle extension manufactured according to the invention according to a first variant in which a forming is carried out in the region of a cooling channel,

FIG. 3 shows the detail illustrated in FIG. 2, which more clearly details the forming process,

FIG. 4 shows an enlarged, perspective detail of a nozzle extension manufactured according to the invention according to a second embodiment variant in which a forming is carried out in the region of a plurality of cooling channels,

FIG. 5 shows an enlarged, perspective detail of a nozzle extension according to the second embodiment variant, and

FIG. 6 shows an enlarged, perspective detail of a nozzle extension manufactured according to the invention according to a third embodiment variant in which a forming is carried out in the region of varying cooling channel numbers.

### DETAILED DESCRIPTION OF THE DRAWINGS

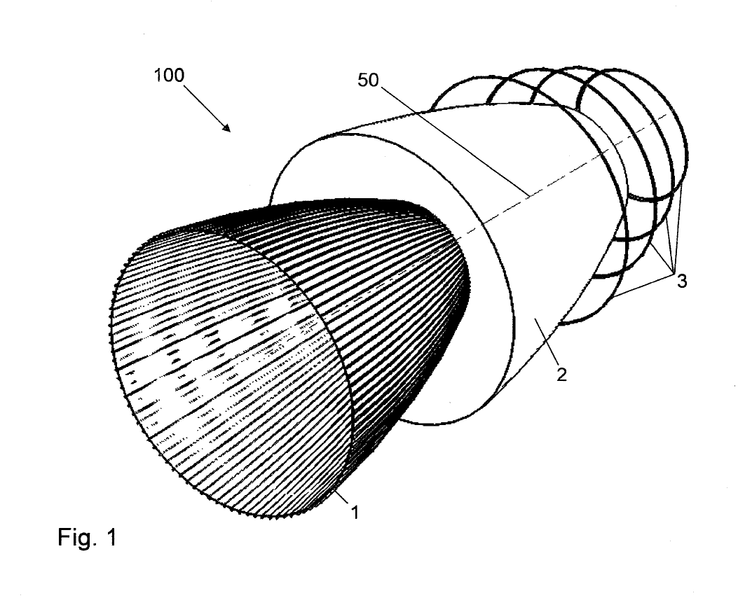

FIG. 1 shows the components necessary for manufacturing a regeneratively cooled nozzle extension 100 in a perspective, exploded illustration. A parabolically shaped first wall, hereinafter referred to as inner liner, is designated with 1. The reference number 2 designates a second wall, hereinafter referred to as outer casing. The reference number 3 designates exemplarily four stiffening rings 3 that can be optionally provided for increasing the stiffness of the nozzle extension. For manufacturing the nozzle extension, first, the inner liner 1 and the outer casing 2 are arranged on top of each other, wherein at least the outer casing 2 initially has a smooth surface contour.

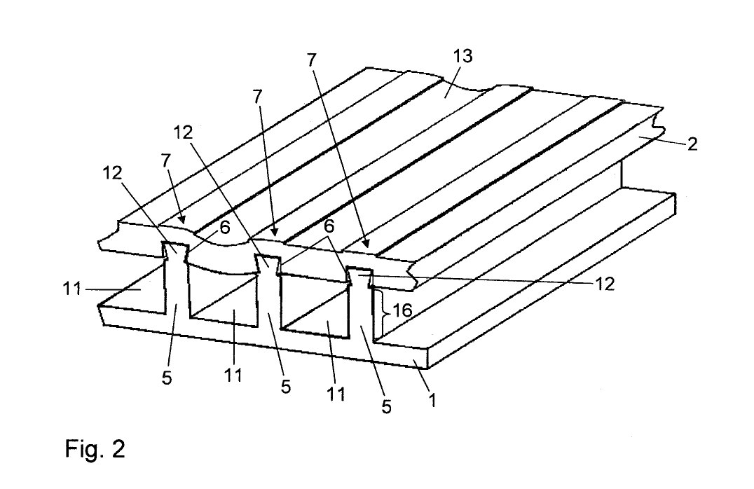

As is shown more clearly in the enlarged details of FIGS. 2 to 6, the inner liner 1 has a number of cooling channel webs 5 or cooling channel webs 5 and 10 extending in the direction of a rotational axis 50 (cf. FIG. 1). The cooling channel webs 5 or 5 and 10 are formed integrally with the inner liner 1, i.e., form one unit with the same. Between respective channel webs 5 or 5 and 10, cooling channels 11 are configured that are laterally delimited by the respective cooling channel webs.

The cooling channel webs 5 differ from the cooling channel webs 10 in their radial length and in the configuration of their ends. While the cooling channel webs' 5 ends 12 facing away from the inner liner 1 are configured like a dovetail that widens from a constriction towards the end, the cooling channel webs' 10 ends 15 facing away from the inner liner 1 are shorter. Moreover, the ends 15 of the cooling channel webs 10 do not have a particular cross-sectional shape.

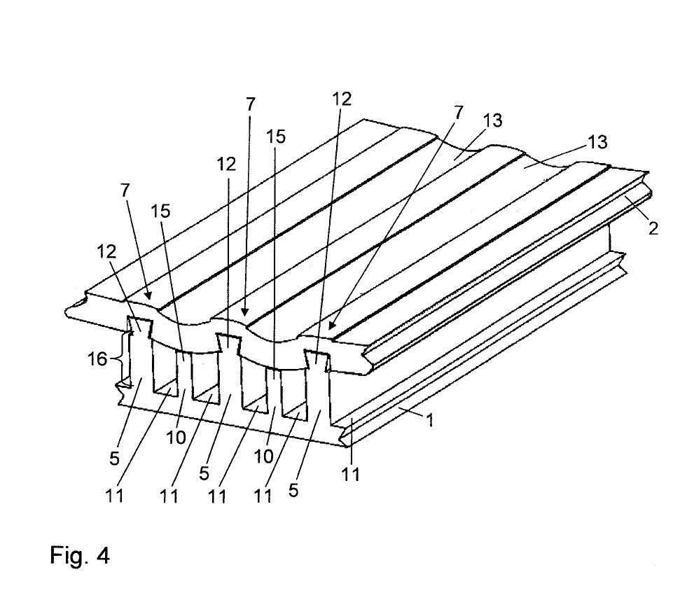

Corresponding to size and arrangement of the cooling channel webs 5 or their ends 12, the outer casing 2 has recesses 6. The recesses 6 extend along the course of the cooling channel webs 5 in the direction of the rotational axis 50. The recesses 6 of the outer casing 2 initially have a rectangular cross-section so that they receive the dovetail-shaped ends 12 of the cooling channel webs 5 when the inner liner 1 and the outer casing 2 are arranged on top of each other. The outermost ends of the dovetail-shaped ends 12 are adapted here to the width of the recesses 6. The total height of the cooling channel webs 10 (if present) is slightly smaller than a respective base 16 of the cooling channel 5 to which base the dovetail-shaped ends 12 are connected (cf. FIG. 2 showing an exemplary embodiment without cooling channel webs 10, and FIG. 4 showing an exemplary embodiment with cooling channel webs 5 and 10). The height of the base 16 or the cooling channel 10 is dimensioned according to the necessary height of the cooling channels 11 and a required flow cross-section.

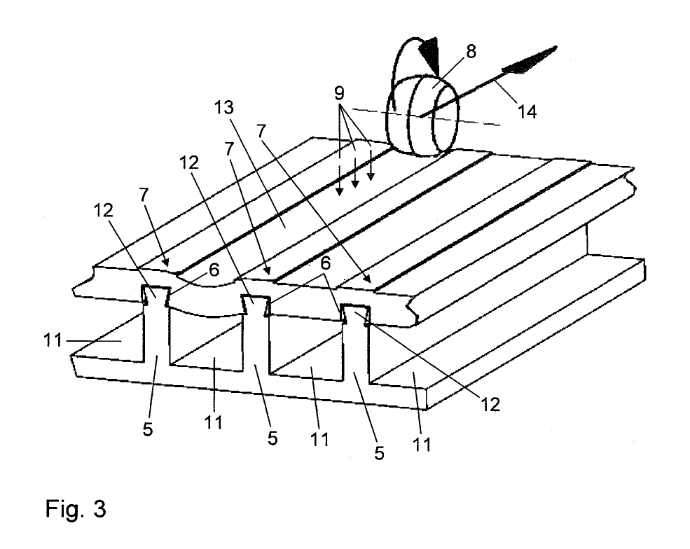

In the FIGS. 2 and 3, a first embodiment variant of a nozzle extension according to the invention is illustrated that has only cooling channel webs 5 with dovetail-shaped ends 12 arranged on the end side. By adequate deformation work on the outer casing 2 in the region between in each case two of the cooling channels 5, the formation of a positive fit 7 (positively fitting connection) in the end region 12 of the cooling channel webs 5 between the inner liner 1 and the outer casing 2 takes place. By the forming which, for example, can be carried out by a roller 8 applying a force 9, the cross-sectional shape of the recesses 6 is changed in such a manner that the walls of the recess 6 adapt to the shape of the dovetail-shaped end 12 of the adjacent cooling channel webs 5. The forming can be carried out by the movement of the roller 8 in the direction indicated with the arrow 14 (cf. FIG. 3).

Producing the positive fit is carried out, for example, in a plurality of steps in a staggered manner over one or a plurality of adjacent cooling channels 11 at the same time, whereby a distortion of the inner contour can be prevented to the greatest possible extent. The force necessary for forming the outer casing 2 is applied by the roller or rollers 8. As a result, the outer casing 2 has a curvature (formed shape 13) directed towards the inner liner 1 in the region of respective formed cooling channels 11 which curvature is obtained by the forming process.

The exemplary embodiments in the FIGS. 4, 5 and 6 have one of the shorter cooling webs 10 between in each case two cooling channel webs 5. The forming of the outer casing 2 in this variant is carried out in such a manner that only every second cooling channel web 5 is used for the formation of a positively fitting connection 7. This means that between the channel webs 5 provided for the positive fit, additional shorter cooling channel webs 10 are attached on the inner liner 1, the height of which shorter webs is determined in consideration of the necessary deformation of the outer casing 2 and the flow conditions. When carrying out the forming in the region between two of the cooling channel webs 5, the force 9 applied by the roller 8 or rollers 8 is such that the outer casing 2 rests on the ends 15 of the cooling channel webs 10.

As a modification of the exemplary embodiments shown in the Figures, it is also possible that more than one of the shorter cooling channel webs 10 is arranged between in each case two cooling channels webs 5. Thus, for example, every third of the cooling channel webs 5, 10 could be used for producing a positive fit.

Due to the deformation of the outer casing 2 which—as the inner liner 1—has a parabolically shaped, rotationally symmetrical initial contour, the stiffness of the nozzle extension 100 increases.

To further increase the stiffness of the nozzle extension, the stiffening rings 3 already mentioned above in connection with FIG. 1 can be provided. The stiffening rings increase the stiffness, in particular, in the region of the geometry changed by the forming process. By an adequate change of the width of the stiffening rings 3 up to a monolithic outer skirt that can be comparable with the length of the nozzle extension or individual sections, the stiffness of the nozzle extension can be maximally optimized.

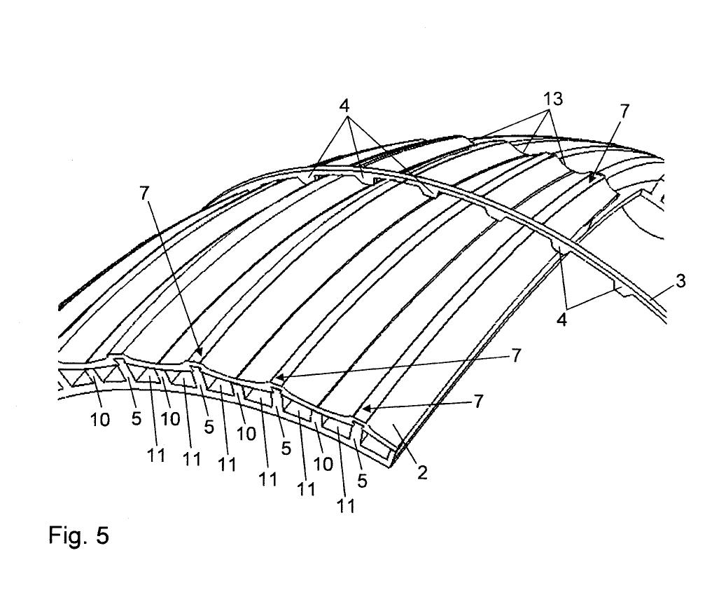

The stiffening rings 3 can also be provided with inner ribs 4 on the side facing the outer casing 2, whereby the shape of the outer casing 2 is raised in the region of the channels when internal pressure is applied. This is exemplary shown in FIG. 5, wherein the inner ribs 4 have a shape which is adapted to the contour of the deformation of the outer casing 2.

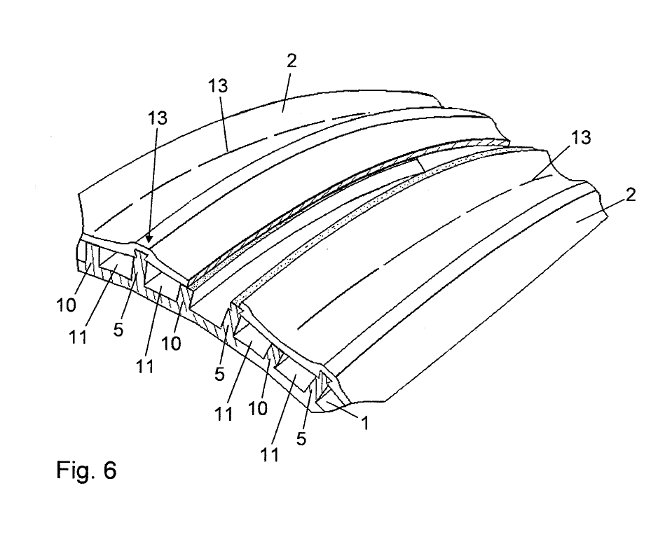

By the selective use of cooling channel webs for connecting the outer casing 2 to the inner liner 1 via cooling channel webs 5 provided for the positive fit, there is further the possibility to use nozzle extensions having a variable number of cooling channel webs. FIG. 6 shows a possible configuration of a nozzle extension with a variable number of cooling channel webs. In the lower region, the connection between the inner liner 1 and the outer casing 2 is carried out via every second cooling channel web 5. In the upper region facing away from the viewer, due to the low number of cooling channel webs, each of the cooling channel webs is used for connecting the outer casing 2 to the inner liner 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE NUMBER LIST

1 Inner liner
2 Outer casing
3 Stiffening ring
4 Inner rib
5 Cooling channel web
6 Recess (of the outer casing)
7 Positive fit
8 Roller
9 Force
10 Cooling channel web
11 Cooling channel
12 End of the cooling channel web 5
13 Formed shape
14 Direction of movement of the roller 8
15 End of the cooling channel web 10
16 Base
50 Rotational axis
100 Nozzle extension

What is claimed is:

1. A method for manufacturing a regeneratively cooled nozzle extension of a rocket combustion chamber, the method comprising:
arranging a first wall and a second wall of the nozzle extension coaxially to each other, wherein a number of cooling channels are configured between the first and second walls, the cooling channels being laterally delimited by cooling channel webs; and
connecting the first and the second wall to each other by a positive fit by engaging cooling channel webs of the first wall with corresponding recesses of the second wall for forming the positive fit, wherein the positive fit is produced by a forming process in a region of the cooling channels of the second wall having the corresponding recesses.

2. The method according to claim 1, wherein forming of the second wall is carried out from a side opposing the first wall.

3. The method according to claim 1, wherein the forming process occurs in a region of one cooling channel or simultaneously in a region of a plurality of cooling channels.

4. The method according to claim 3, wherein for manufacturing the complete nozzle extension, the positive fit is generated in the region of one or a plurality of cooling channels in a plurality of sequentially staggered method steps.

5. The method according to claim 2, wherein a force necessary for forming the second wall is applied by one or a plurality of rollers arranged side-by-side or one above the other.

6. The method according to claim 2, wherein excess pressure or negative pressure is used for forming the second wall.

7. The method according to claim 1, wherein prior to the forming process, the first and the second walls are arranged as a whole in an axial direction one above the other in such a manner that web ends remote from the first wall of at least some of the cooling channel webs project into the recesses.

8. The method according to claim 1, wherein the forming process takes place in a region between two directly adjacent cooling channel webs.

9. The method according to claim 1, wherein the forming process takes place in a region of one or a plurality of adjacent cooling channel webs in such a manner that the second wall is brought into abutment against a web end remote from the first wall of one or a plurality of cooling channel webs without producing a positive fit, wherein the positive fit between the first and the second wall takes place at least by each of the cooling channel webs adjacent to the cooling channels webs.

10. The method according to claim 9, wherein the forming process takes place in such a manner that each nth cooling channel web is connected to the second wall in a positively fitting manner, wherein n is greater than 2.

11. The method according to claim 1, wherein at least one stiffening ring having a predetermined axial length is brought into abutment against the second wall of the nozzle extension so that the stiffening ring lies in a plane orthogonal to a rotational axis of the nozzle extension.

12. The method according to claim 11, wherein the at least one stiffening ring has a projection adapted in respective forming regions to a shape of the respective forming regions.

13. A regeneratively cooled nozzle extension for a rocket combustion chamber, the nozzle extension comprising:
a first wall;
a second wall arranged coaxially to the first wall; and
a number of cooling channels configured between the first and second walls, the cooling channels being laterally delimited by cooling channel webs,
wherein the first and the second wall are positively fit connected to each other by cooling channel webs of the first wall engaged with corresponding recesses of the second wall, and
wherein in a region of a respective positive fit, the recesses of second wall are formed in a region of the cooling channels.

14. The nozzle extension according to claim 13, wherein the first and the second wall each have a rotationally symmetrical, parabolic initial contour.

15. The nozzle extension according to claim 13, wherein every nth cooling channel web is connected to the second wall in a positively fitting manner, wherein n is greater than 2.

16. The nozzle extension according to claim 13, wherein a stiffening ring having a predetermined axial length abutments against the second wall so that the stiffening ring lies in a plane orthogonal to a rotational axis of the nozzle extension.
